(19) United States
(12) Patent Application Publication
(10) Pub. No.: US 2025/0148140 A1
(43) Pub. Date: May 8, 2025

(54) METHOD AND APPARATUS FOR SELECTING POSITIONS OF PHYSICAL SENSORS AND VIRTUAL SENSORS

(71) Applicant: Electronics and Telecommunications Research Institute, Daejeon (KR)

(72) Inventors: Young Hoon Kwak, Seoul (KR); Jung Ho Huh, Seoul (KR); Hak Jong Shin, Seoul (KR); Ja Bin Goo, Seoul (KR)

(21) Appl. No.: 18/500,537

(22) Filed: Nov. 2, 2023

(30) Foreign Application Priority Data
Oct. 13, 2023 (KR) 10-2023-0137024

(51) Int. Cl. G06F 30/13; G01D 18/00

(52) U.S. Cl. CPC G06F 30/13; G01D 18/00

(57) ABSTRACT

A method and device for positioning physical sensors and virtual sensors is disclosed. The positioning method performed by the positioning device for selecting each of the positions of the physical sensors and the virtual sensors in an indoor space includes: generating a position-related combination of the physical sensors and the virtual sensors based on the number of nodes of the physical sensors; calculating performance of the virtual sensors for each generated combination; determining whether there is a combination in which the performance of all virtual sensors satisfies a preset criterion among the calculated results; and selecting, when there is a combination that satisfies the preset criterion, positions included in the combination as positions of the physical sensors and the virtual sensors.

### CROSS-REFERENCE TO RELATED APPLICATION

This application claims priority to and the benefit of Korean Patent Application No. 10-2023-0137024 filed in the Korean Intellectual Property Office on Oct. 13, 2023, the entire contents of which are incorporated herein by reference.

### TECHNICAL FIELD

The present disclosure relates to a device for positioning sensors, and more particularly to a method and device for positioning physical sensors and virtual sensors, which reduces the usage of the physical sensors while maintaining measurement performance through a combination of the physical sensors and the virtual sensors.

### BACKGROUND

In general, a large number of sensor nodes are preferred for the development of digital twins within built environments. However, installing and operating a large number of physical sensors is costly, so it is necessary to approach optimal physical sensor placement and virtual sensor operation considering economics and information volume.

To address this need, recently researched data-driven sensor placement methodologies have the characteristic of deriving optimal placement by ranking and clustering sensor positions through statistical indicators, information quality, and device reception strength. However, in terms of spatially extended virtual sensor operation, physical sensor positions determined based on these indirect values are difficult to fully guarantee the performance of data-based prediction models (virtual sensors) due to issues such as multicollinearity and overfitting.

Accordingly, there is a need for a sensor placement method that can sufficiently reflect the performance of virtual sensors.

### SUMMARY

In view of the above, the present disclosure provides a method and device for positioning physical sensors and virtual sensors, which analyzes the performance of the virtual sensors for each of combinations of the physical sensors and the virtual sensors, and based on the analyzed results, derives the positions of the sensors where the predictive performance of the virtual sensors is maximized, and indicates the optimal placement to reduce the usage of the physical sensors while maintaining measurement performance.

A positioning method performed by a positioning device that selects a position of each of physical sensors and virtual sensors in an indoor space, in accordance with the present disclosure, comprises: generating a position-related combination of the physical sensors and the virtual sensors based on the number of nodes of the physical sensors; calculating performance of the virtual sensors for each generated combination; determining whether there is a combination in which the performance of all virtual sensors satisfies a preset criterion among the calculated results; and selecting, when there is a combination that satisfies the preset criterion, positions included in the combination as positions of the physical sensors and the virtual sensors.

In addition, the positioning method further comprises: selecting, when there is no combination that satisfies the preset criterion, a promising combination that affects performance of other virtual sensors more than a preset level and a challenging node, which is a node where virtualization of a virtual sensor is difficult; updating a parameter set that determines the number of cases related to the combination based on the promising combination and the challenging node that are selected; and regenerating the combination based on the updated parameter set and repeating the positioning process based on the regenerated combination until the positions of the physical sensors and the virtual sensors are selected.

In the selecting of the promising combination and the challenging node, the nodes of the physical sensors corresponding to the combination with a best performance of the virtual sensors among the combinations are selected as the promising combination.

In the selecting of the promising combination and the challenging node, a node of a virtual sensor that does not satisfy the preset criterion in the promising combination is selected as the challenging node.

In the selecting of the promising combination and the challenging node, after a greater weight is assigned to the virtual sensor as the performance of the virtual sensor is greater than the preset criterion, and a smaller weight is assigned to the virtual sensor as the performance of the virtual sensor is smaller than the preset criterion, the promising combination and the challenging node are selected.

In the updating, the parameter set is updated to reduce the number of the cases.

In the calculating, the performance of the virtual sensors is calculated using the mean absolute error.

In the determining, as a size of the indoor space increases, a tolerance range for the preset criterion is set larger.

A positioning device for selecting a position of each of physical sensors and virtual sensors in an indoor space, in accordance with the present disclosure, comprises: a combination generating unit that generates a position-related combination of the physical sensors and the virtual sensors based on the number of nodes of the physical sensors; a performance evaluation unit that calculates performance of the virtual sensors for each generated combination and determines whether there is a combination in which the performance of all virtual sensors satisfies a preset criterion among the calculated results; and a position selection unit that when there is a combination that satisfies the preset criterion, selects positions included in the combination as positions of the physical sensors and the virtual sensors.

A positioning system in accordance with the present disclosure comprises: a positioning device for selecting a position of each of physical sensors and virtual sensors in an indoor space; and a user terminal that receives information related to the selected positions of the physical sensors and the virtual sensors from the positioning device and outputs the received information, wherein the positioning device includes: a combination generating unit that generates a position-related combination of the physical sensors and the virtual sensors based on the number of nodes of the physical sensors; a performance evaluation unit that calculates performance of the virtual sensors for each generated combination and determines whether there is a combination in which the performance of all virtual sensors satisfies a preset criterion among the calculated results; and a position selection unit that when there is a combination that satisfies the preset criterion, selects positions included in the combination as positions of the physical sensors and the virtual sensors.

According to embodiments of the present disclosure, among the combinations of the physical sensors and the virtual sensors that can be derived for sensor nodes at all points, the most economical combination can be selected while ensuring sufficient performance of the virtual sensors.

Through this, the present disclosure can reduce the usage of the physical sensors and increase the usage of the virtual sensors, resulting in easy maintenance and cost savings.

### BRIEF DESCRIPTION OF THE DRAWINGS

FIG. 1 is a block diagram for explaining a positioning system according to one embodiment of the present disclosure.

FIG. 2 is a block diagram for explaining the positioning device according to one embodiment of the present disclosure.

FIG. 3 is a diagram for explaining a positioning process of physical sensors and virtual sensors according to one embodiment of the present disclosure.

FIG. 4 is a diagram for explaining an optimal placement algorithm according to one embodiment of the present disclosure.

FIG. 5 is a block diagram for explaining a control unit according to one embodiment of the present disclosure.

FIGS. 6 and 7 are diagrams for explaining a breeding farm used to perform a simulation of the optimal placement algorithm according to one embodiment of the present disclosure.

FIGS. 8, 9, 10, and 11 are diagrams for explaining a simulation process according to one embodiment of the present disclosure.

FIG. 12 is a flowchart for explaining a positioning method according to one embodiment of the present disclosure.

FIGS. 13 and 14 are diagrams comparing and analyzing the performance difference between conventional positioning methods and the positioning method of the present disclosure.

FIG. 15 is a block diagram for explaining a computing device according to one embodiment of the present disclosure.

### DETAILED DESCRIPTION

Embodiments of the present disclosure are described below with reference to the accompanying drawings in detail so that one of ordinary skill in the art to which the present disclosure pertains can easily practice the present disclosure. However, the present disclosure may be implemented in many different forms and is not limited to the embodiments described herein. In order to clearly illustrate the present disclosure in the drawings, parts that are not related to the description have been omitted, and like parts are designated by like reference numerals throughout the specification.

In the present specification and drawings (hereinafter referred to as “present specification”), duplicate descriptions of the same component are omitted.

In addition, in the present specification, when it is described that a component is “coupled” or “connected” to another component, it is to be understood that the component may be directly coupled or connected to another component, but that there may be other components therebetween. On the other hand, when it is described that a component is “directly coupled” or “directly connected” to another component, it is to be understood that there are no other components therebetween.

Further, the terms used in the present specification are merely used to describe specific embodiments and are not intended to limit the present disclosure.

Also, in the present specification, singular expressions may include plural expressions, unless the context clearly indicates otherwise.

Furthermore, in the present specification, the terms “comprising”, “including”, “having” and the like are intended to designate the presence of the features, numbers, steps, operations, components, parts, or combinations thereof described herein, and are not to be understood as precluding the possibility of the presence or addition of one or more other features, numbers, steps, operations, components, parts, or combinations thereof.

Further, in the present specification, the term “and/or” includes any combination of a plurality of recited items or any one of the plurality of recited items. In the present specification, the term “A or B” may include “A”, “B”, or “both A and B”.

In addition, in the specification, detailed descriptions of known functions and configurations that may obscure the gist of the present disclosure will be omitted.

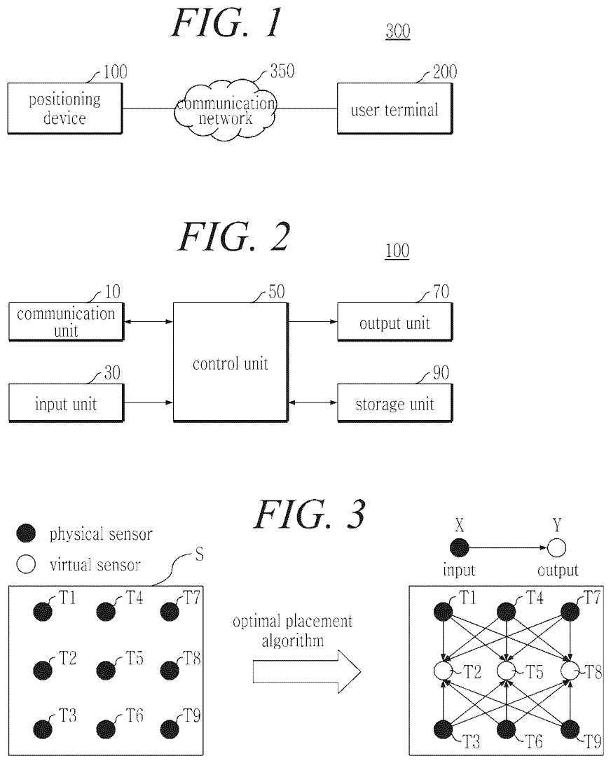

FIG. 1 is a block diagram for explaining a positioning system according to one embodiment of the present disclosure.

Referring to FIG. 1, the positioning system 300 analyzes, through combinations of physical sensors and virtual sensors, the performance of the virtual sensors for each combination, and based on the analyzed results, derives the position of the sensors where the predictive performance of the virtual sensors is maximized, thereby providing an optimal placement that reduces the usage of the physical sensors while maintaining the measurement performance. In this case, the physical sensors and virtual sensors may include temperature sensors, humidity sensors, ammonia sensors, carbon dioxide sensors, illumination sensors, and the like. The positioning system 300 includes a positioning device 100 and a user terminal 200.

The positioning device 100 positions each of the physical sensors and the virtual sensors in the indoor space. Using a minimum number of physical sensors, a combination that can satisfy the required performance criteria of the virtual sensors is derived. For this purpose, the positioning device 100 classifies nodes with excellent virtual sensor development ability and nodes that are difficult to develop virtual sensors based on the performance of the virtual sensors for each combination. In this case, the virtual sensor development means having a positive impact on the performance of other virtual sensors. By repeatedly performing the positioning process using the classified nodes, the positioning device 100 can derive an optimal combination of physical sensors and virtual sensors, and select the derived positions as the positions of the physical sensors and virtual sensors.

The user terminal 200 is a terminal used by a user and receives information related to the selected positions of the physical sensors and the virtual sensors from the positioning device 100. The user terminal 200 outputs the received information. The user terminal 200 may also output performance figures of the virtual sensors. In this way, the user terminal 200 can intuitively inform the user of the optimized positions of the sensors.

The positioning system 300 establishes a communication network 350 between the positioning device 100 and the user terminal 200 to communicate with each other. The communication network 350 may comprise a backbone network and a subscriber network. The backbone network may comprise one or more integrated networks among the X.25 network, Frame Relay network, ATM network, MPLS (Multi-Protocol Label Switching) network, and GMPLS (Generalized Multi-Protocol Label Switching) network. The subscriber network may include FTTH (Fiber To The Home), ADSL (Asymmetric Digital Subscriber Line), cable network, Zigbee, Bluetooth, and Wireless LAN (IEEE 802.11b, IEEE 802.11a, IEEE 802.11g, IEEE 802.11n), Wireless Hart (ISO/IEC 62591-1), ISA100.11a (ISO/IEC 62734), CoAP (Constrained Application Protocol), MQTT (Message Queuing Telemetry Transport), WIBro (Wireless Broadband), Wimax, 3G, HSDPA (High Speed Downlink Packet Access), 4G, 5G, 6G, etc. In some embodiments, the communication network 350 may be an Internet network or a mobile communication network. Further, the communication network 350 may include any wireless or wired communication method that is widely known or may be developed in the future.

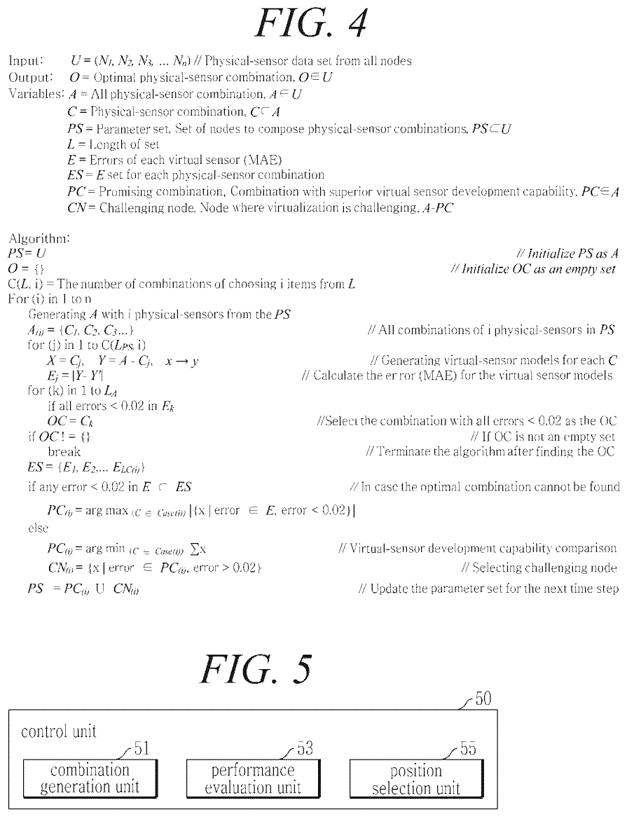

FIG. 2 is a block diagram for explaining the positioning device according to one embodiment of the present disclosure, FIG. 3 is a diagram for explaining the positioning process of the physical sensors and the virtual sensors according to one embodiment of the present disclosure, and FIG. 4 is a diagram for explaining an optimal placement algorithm according to one embodiment of the present disclosure.

Referring to FIGS. 1 to 4, the positioning device 100 includes a communication unit 10, an input unit 30, a control unit 50, an output unit 70, and a storage unit 90.

The communication unit 10 performs communication with the user terminal 200. The communication unit 10 transmits information related to the selected positions of the physical and the virtual sensors to the user terminal 200. The communication unit 10 may receive user input for selecting the positions of the physical sensors and the virtual sensors from the user terminal 200.

The user input for selecting the positions of the physical sensors and the virtual sensors is input through the input unit 30. In this case, the user input may include information related to the performance of the physical sensors, information (size, shape, usage, etc.) related to the indoor space S in which the physical sensors and the virtual sensors are located, criteria for judging the performance of the virtual sensors, and the like.

The control unit 50 performs overall control of the positioning device 100. The control unit 50 may use an optimal placement algorithm to select the positions of the physical sensors and the virtual sensors, and the optimal placement algorithm is a method of evaluating the virtual sensor development ability and the ease of virtualization for each node and may derive an optimal combination of the physical sensors and the virtual sensors. The optimal placement algorithm may be expressed in pseudocode based on the Python language, as shown in FIG. 3. In this case, the optimal placement algorithm defines a promising combination (PC), which means that the virtual sensor development ability is excellent and is promising to become an optimal combination (OC), and a challenging node (CN), which means a node that is difficult to virtualize, and the algorithm is performed using the promising combination and the challenging node. In other words, the promising combination refers to a combination of nodes that are likely to be virtual sensors (e.g., T2, T5, T8), and the challenging node refers to a node that is likely to have a physical sensor rather than a virtual sensor (e.g., T1, T3, T4, T6, T7, T9). The process of the optimal placement algorithm is performed through the control unit 50 as follows.

Specifically, the control unit 50 generates a position-related combination of the physical sensors and the virtual sensors based on the number of nodes of the physical sensors. The control unit 50 calculates the performance of the virtual sensors for each generated combination. In this case, the control unit 50 may calculate the performance of the virtual sensors using the mean absolute error (MAE). The control unit 50 determines whether there is a combination in which the performance of all virtual sensors satisfies a preset criterion among the calculated results. The preset criterion may be MAE<0.01 to 0.05, and preferably MAE<0.02. If there is a combination that satisfies the preset criterion, the control unit 50 selects the positions included in the combination as the positions of the physical sensors and the virtual sensors. In addition, if there is no combination that satisfies the preset criterion, the control unit 50 selects a promising combination that affects the performance of other virtual sensors more than a preset level, and a challenging node, which is a node where virtualization of a virtual sensor is difficult. The control unit 50 updates a parameter set that determines the number of cases related to combination based on the selected promising combination and challenging node. The control unit 50 regenerates a combination based on the updated parameter set and repeats the positioning process until the positions of the physical sensors and the virtual sensors are selected based on the regenerated combination.

The output unit 70 outputs the process of selecting the positions of the physical sensors and the virtual sensors placed in the indoor space. That is, the output unit 70 may output a simulation process for position selection. The output unit 70 may be a display, and the display may include at least one of a liquid crystal display (LCD), a thin film transistor-liquid crystal display (TFT LCD), an organic light-emitting diode (OLED, a flexible display, and a 3D display.

The storage unit 90 stores a program or algorithm for driving the positioning device 100. The storage unit 90 stores information that is generated, selected, calculated, and updated in the process of selecting the positions of the physical sensors and the virtual sensors placed in the indoor space. The storage unit 90 may include at least one storage medium among a flash memory type memory, a hard disk type memory, a multimedia card micro type memory, a card type memory (e.g., SD or XD memory, etc.), RAM (Random Access Memory), SRAM (Static Random Access Memory), ROM (Read-Only Memory), EEPROM (Electrically Erasable Programmable Read-Only Memory), PROM (Programmable Read-Only Memory), a magnetic memory, a magnetic disk, and an optical disk.

FIG. 5 is a block diagram for explaining the control unit according to one embodiment of the present disclosure.

Referring to FIGS. 1 to 5, the control unit 50 includes a combination generation unit 51, a performance evaluation unit 53, and a position selection unit 55.

The combination generation unit 51 sets initial values for performing the optimal placement algorithm. The combination generation unit 51 sets the initial value of the number i (i is a natural number) of nodes of the physical sensors to 1 to perform the first timestep of the optimal placement algorithm. The combination generation unit 51 generates a position-related combination of the physical sensors and the virtual sensors, with i being the number of nodes of the physical sensor, based on a parameter set that determines the number of combination cases. In this case, the number of virtual sensor nodes is n-i, where n means the number of sensor nodes provided in the indoor space S. Meanwhile, when at least one of the number of nodes of the physical sensors and the parameter set is updated, the combination generation unit 51 may reflect the updated information and generate a combination of sensors to perform the next step, the m-th (m is a natural number) timestep.

The performance evaluation unit 53 evaluates the performance of the virtual sensors for each generated combination. The performance evaluation unit 53 calculates the performance of the virtual sensors included in each combination using the mean absolute error. That is, the performance evaluation unit 53 may quantify the performance of the virtual sensor at the corresponding node by determining the error based on the difference between an actual value and a predicted value of the virtual sensor. The performance evaluation unit 53 determines whether there is a combination in which the performance of all virtual sensors satisfies a preset criterion. In this case, the preset criterion may be MAE<0.01 to 0.05, and preferably MAE<0.02. Further, the performance evaluation unit 53 may set a tolerance range for the preset criterion to be larger as the size of the indoor space S increases. For example, when the size of the indoor space S to be measured increases while the number of sensor nodes is fixed, the performance evaluation unit 53 may increase the range of the preset criterion from 0.02 to 0.05.

If there is a combination that satisfies a preset criterion, the position selection unit 55 selects the positions included in the combination as the positions of the physical sensors and the virtual sensors. The position selection unit 55 may derive the selected positions of the physical sensors and the virtual sensors as the optimal positions. In this case, the positions of the physical and virtual sensors finally derived may be the most economical (minimum usage of physical sensors) positions where all virtual sensors can demonstrate the performance of physical sensors.

If there is no combination that satisfies the preset criterion, the position selection unit 55 selects a promising combination (PC) that affects the performance of other virtual sensors more than a preset level. The position selection unit 55 may select the promising combination based on the number of virtual sensors that satisfy the preset criterion and the average performance of the virtual sensors. Further, the position selection unit 55 selects a challenging node (CN), which is a node where virtualization of a virtual sensor is difficult. The position selection unit 55 may select a node of a virtual sensor that does not satisfy the preset standard among virtual sensors developed in the promising combination as the challenging node. The position selection unit 55 updates a parameter set (PS) that determines the number of cases related to combination based on the promising combination and the challenging node that are selected. In this way, the position selection unit 55 updates the parameter set at each timestep, thereby preventing the generation of unnecessary combinations and reducing the amount of calculation work. The position selection unit 55 controls the updated parameter set to be applied to the next timestep, enabling the combination generation unit 51 to perform the next timestep through the updated parameter set.

Hereinafter, a simulation process of applying the optimal arrangement algorithm of the present disclosure to a cattle shed will be described.

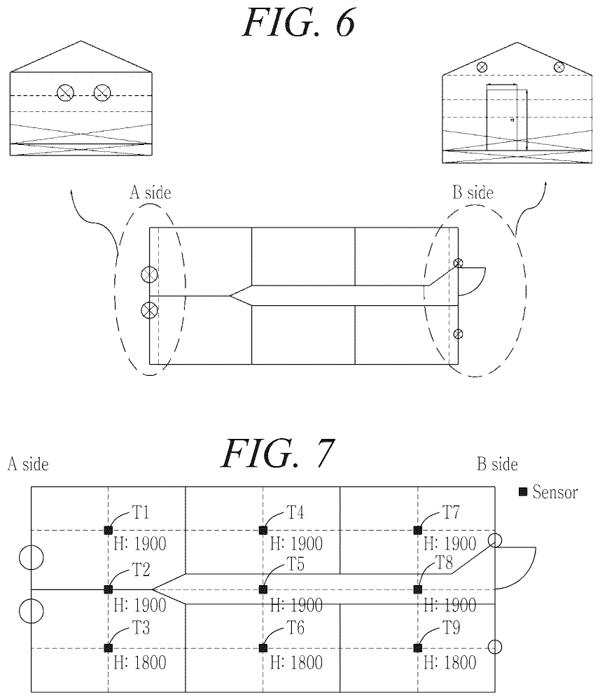

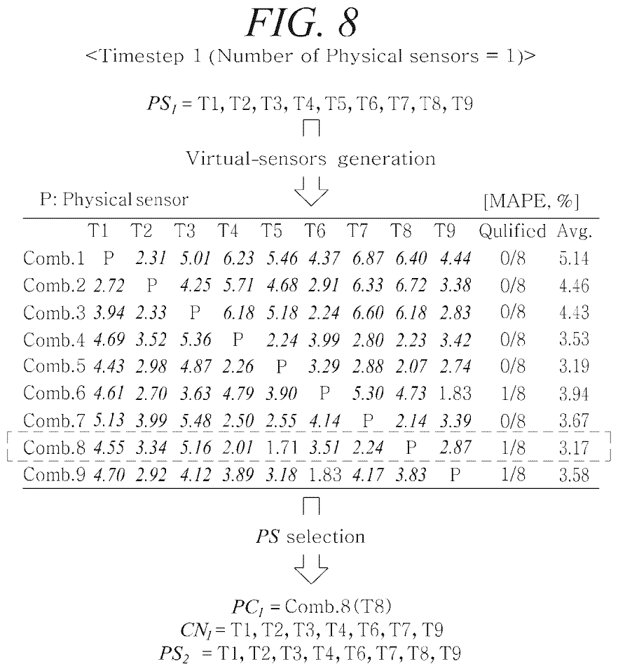

FIGS. 6 and 7 are diagrams for explaining a breeding farm used to perform a simulation of the optimal placement algorithm according to one embodiment of the present disclosure, and FIGS. 8, 9, 10 and 11 are diagrams for explaining the simulation process according to one embodiment of the present disclosure.

Referring to FIGS. 1 and 6 to 11, the simulation was carried out for a cattle shed for raising pigs. The interior of the cattle shed had a roof as shown in FIG. 6 and was equipped with air circulation devices on the A and B sides, respectively. The air circulation device applies PID (Proportional Integral Differential) control based on the room temperature, and the control logic is determined to maintain 28° C. In addition, data was collected for one month at 9 points (T1, T2, T3, T4, T5, T6, T7, T8, T9) through physical sensors (temperature sensors) to obtain correct answer data that serves as a reference for judging the performance of simulation values.

At the first timestep Timestep 1 (FIG. 8), the positioning device examines all combinations of using one physical sensor and virtual sensors for the remaining eight nodes. In this case, a parameter set PS₁ of all 9 initial physical sensors is applied to derive combinations. After developing all virtual sensors for each combination, the positioning device 100 detects combinations in which the error rate of all virtual sensors is less than 2% based on the mean absolute percentage error (MAPE) value calculated through performance evaluation. In this case, the error rate may be changed depending on the environment in which the sensors are placed. The examination results show that there is no combination that satisfies the conditions in the first timestep Timestep 1, so that the positioning device 100 updates a parameter set PS₂ of the second timestep Timestep 2. Specifically, the positioning device 100 selects the 8th combination including one T8 physical sensor as a promising combination PC₁ based on the number of virtual sensors satisfying 98% and the comparison of the average performance of the virtual sensors, and selects the remaining sensor nodes T1, T2, T3, T4, T6, T7, T9, except for sensor node T5 that succeeded in developing a virtual sensor and sensor node T8 that is provided with a physical sensor, in the 8th combination as the challenging node CN₁. In addition, the positioning device 100 excludes the T5 sensor node, which succeeded in developing a virtual sensor in the 8th combination, from the parameter set PS₂ of the second timestep Timestep 2.

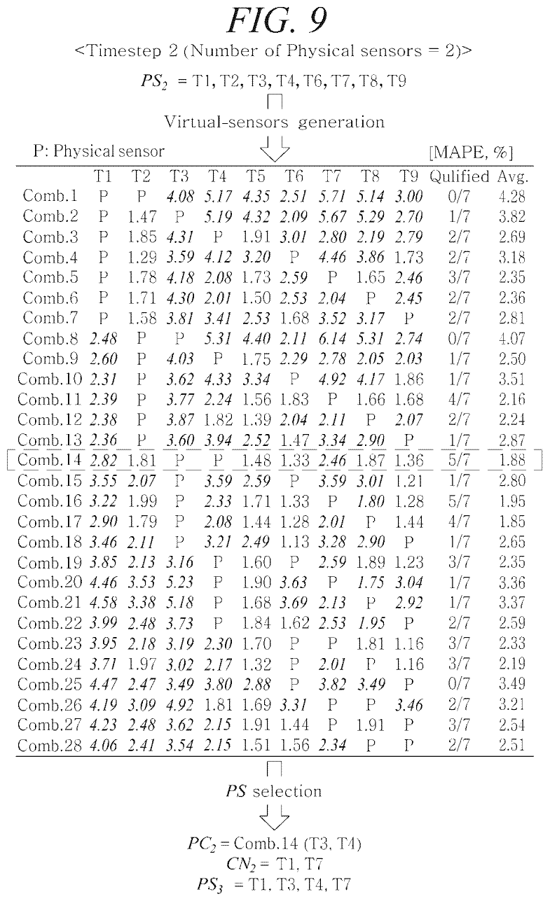

At the second timestep Timestep 2 (FIG. 9), the positioning device 100 examines all combinations that use two physical sensors and virtual sensors for the remaining seven nodes based on the updated parameter set PS₂ of T1, T2, T3, T4, T6, T7, T8, T9. In this case, the positioning device 100 generates combinations by placing physical sensors only at sensor nodes T1, T2, T3, T4, T6, T7, T8, T9 that correspond to the parameter set PS₂. The examination results show that there is no combination that satisfies the performance of all virtual sensors, so that the positioning device 100 updates a parameter set PS₃ of the third timestep Timestep 3. Specifically, the positioning device 100 selects the 14th combination including two physical sensors T3 and T4 as the promising combination PC2 based on the number of virtual sensors satisfying 98% and the comparison of the average performance of the virtual sensors, and selects the remaining sensor nodes T1, T7, except for sensor nodes T2, T5, T6, T8, T9 that succeeded in developing virtual sensors and sensor nodes T3, T4 that are provided with physical sensors, in the 14th combination as challenging nodes CN₂. In addition, the positioning device 100 excludes sensor nodes T2, T5, T6, T8, T9, which succeeded in developing virtual sensors in the 14th combination, from the parameter set PS₃ of the third timestep Timestep 3.

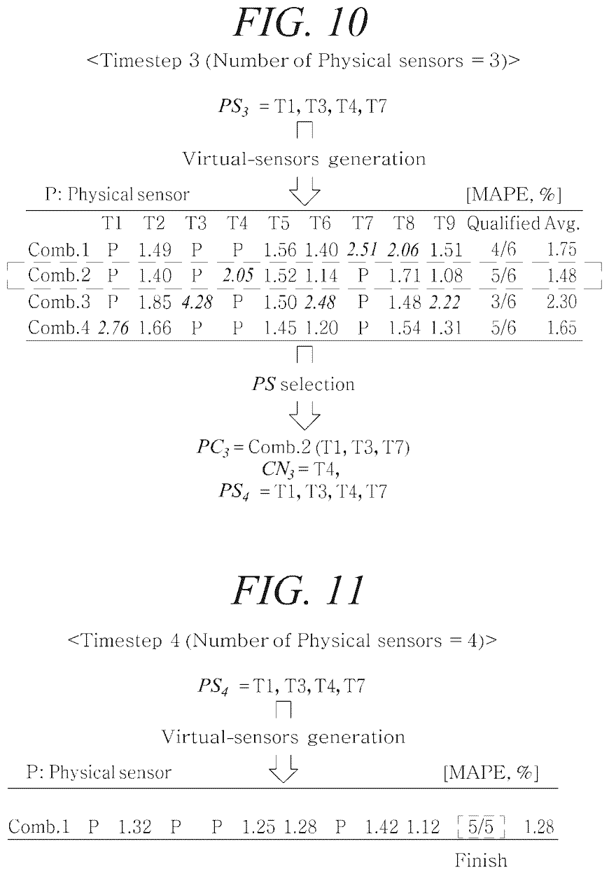

At the third timestep Timestep 3 (FIG. 10), the positioning device 100 examines all combinations that use three physical sensors and virtual sensors for the remaining five nodes based on the updated parameter set PS₃ of T1, T3, T4, T7. In this case, the positioning device 100 generates combinations by placing physical sensors only at sensor nodes T1, T3, T4, T7 corresponding to the parameter set PS₃. The examination results show that there is no combination that satisfies the performance of all virtual sensors, so that the positioning device 100 updates a parameter set PS₄ of the fourth timestep Timestep 4. Specifically, the positioning device 100 selects the second combination including three physical sensors T1, T3, T7 as a promising combination PC₃ based on the number of virtual sensors satisfying 98% and the comparison of the average performance of the virtual sensors, and selects the remaining sensor nodes T4, except for sensor nodes T2, T5, T6, T8, T9 that succeeded in developing virtual sensors and sensor nodes T1, T3, T7 that are provided with physical sensors, in the second combination, as challenging nodes CN₃. In addition, the positioning device 100 excludes sensor nodes T2, T5, T6, T8, T9 that succeeded in developing virtual sensors in the second combination from the parameter set PS₄ of the fourth timestep Timestep 4.

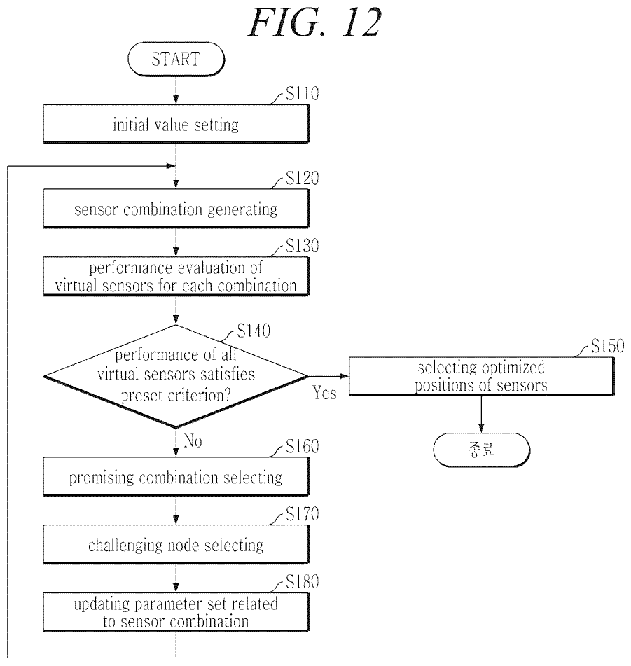

At the fourth timestep Timestep 4 (FIG. 11), the positioning device 100 examines all combinations that use four physical sensors and virtual sensors for the remaining five nodes based on the updated parameter set PS₄ of T1, T3, T4, T7. In this case, the positioning device 100 generates a first combination, which is one combination, by placing physical sensors at sensor nodes T1, T3, T4, T7 corresponding to the parameter set PS₄. The examination results show that the error rate of all virtual sensors T2, T5, T6, T8, T9 in the first combination is less than 2% and the average error rate is 1.28%, so that the positioning device 100 can select the corresponding combination as the optimal positions of the sensors.

That is, the positioning device 100 may repeat the above-described process until a combination of all virtual sensors with an error rate of less than 2% is obtained, and when a combination with an error rate of less than 2% is derived, the corresponding combination can be selected as the optimal positions of the physical sensors and the virtual sensors.

FIG. 12 is a flowchart for explaining a positioning method according to one embodiment of the present disclosure.

Referring to FIGS. 1 and 12, the positioning method can select the most economical combination among combinations of physical sensors and virtual sensors that can be derived for sensor nodes at all points while ensuring sufficient performance of the virtual sensors. Through this, the positioning method can reduce the usage of physical sensors and increase the usage of virtual sensors, resulting in easier maintenance and cost savings.

In step S110, the positioning device 100 sets an initial value. The positioning device 100 sets an initial value for performing the optimal placement algorithm. In order to perform the first timestep of the optimal placement algorithm, the positioning device 100 sets the initial value by setting the number i (i is a natural number) of nodes of the physical sensors to 1.

In step S120, the positioning device 100 generates a sensor combination. The positioning device 100 generates a position-related combination of the physical sensors and the virtual sensors where the number of nodes of the physical sensors is i, based on a parameter set that determines the number of combination cases. In this case, the number of nodes of the virtual sensors is n-i, where n means the number of sensor nodes provided in the indoor space. Meanwhile, when at least one of the number of nodes of the physical sensors and the parameter set is updated, the positioning device 100 may reflect the updated information and generate a combination of sensors to perform the next step, the m-th (m is a natural number) timestep.

In step S130, the positioning device 100 performs performance evaluation of the virtual sensors for each combination. The positioning device 100 calculates the performance of the virtual sensors included in each combination using the mean absolute error (MAE). That is, the positioning device 100 can quantify the performance of the virtual sensors at the corresponding node by determining the error based on the difference between an actual value and a predicted value of the virtual sensor.

In step S140, the positioning device 100 determines whether the performance of all the virtual sensors satisfies preset criterion. The positioning device 100 performs step S160 if the performance of all the virtual sensors satisfies the preset criterion, and performs steps S170 and S180 if all the virtual sensors do not satisfy of the preset criterion. In this case, the preset criterion may be MAE<0.01 to 0.05, and preferably MAE<0.02.

In step S150, the positioning device 100 selects the optimized positions of the sensors. The positioning device 100 selects positions included in a combination that satisfies the preset criterion as the positions of the physical sensors and the virtual sensors. In this case, the selected positions of the sensors may be the most economical position (minimum usage of physical sensors) where all virtual sensors can demonstrate the performance of physical sensors.

In step S160, the positioning device 100 selects a promising combination. The positioning device 100 selects a promising combination (PC) based on the number of virtual sensors that satisfy the preset criterion and the average performance of the virtual sensors. The promising combination refers to a combination of physical sensors that affect the performance of other virtual sensors more than a preset level.

In step S170, the positioning device 100 selects a challenging node. The positioning device 100 selects a challenging node, which is a node where virtualization of the virtual sensor is difficult. The positioning device 100 may select a node of a virtual sensor that does not satisfy the preset criterion among virtual sensors developed in the promising combination as the challenging node.

In step S180, the positioning device 100 updates the parameter set that determines the number of cases related to the sensor combination. The positioning device 100 may update the parameter set based on the promising combination and the challenging node. In this case, the positioning device 100 may update the parameter set to generate a combination in which the number of nodes of the physical sensors is gradually increased from the most economical combination (with the smallest number of nodes of the physical sensors). The positioning device 100 transfers the updated parameter set to step S120 to support the generation of a sensor combination at the next timestep. Through this, the positioning device 100 updates the parameter set at each timestep, thereby preventing the generation of unnecessary combinations and reducing the amount of calculation work.

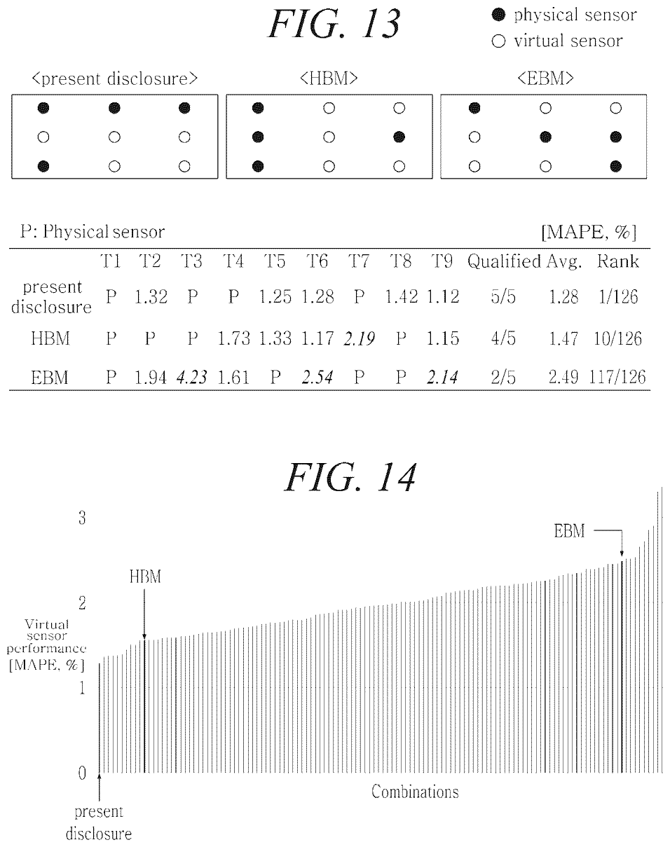

FIGS. 13 and 14 are diagrams comparing and analyzing the performance differences between conventional positioning methods and the positioning method of the present disclosure.

Referring to FIGS. 13 and 14, the performance of the positioning method of the present disclosure was verified through comparison in terms of virtual sensor development ability with other data-based physical sensor positioning methods. The verification was conducted using a combination of four physical sensors. In this case, the methodologies corresponding to the conventional methods are HBM (HSIC-based method) and EBM (Error-based method). HBM is a greedy algorithm that selects the physical sensor configuration for each number of sensor nodes based on HSIC indicator, and EBM is an algorithm that uses an average value of all sensors in a building as a representative measurement value.

FIG. 13 shows a combination of physical sensors (four physical sensors) derived for each methodology and the performance of five virtual sensors derived for each methodology. Only the positioning method of the present disclosure was the methodology that satisfied the performance of all virtual sensors, while HBM and EBM satisfied the performance of three and two virtual sensors, respectively. The positioning method of the present disclosure was also the methodology with the lowest average error rate of the five virtual sensors, and the virtual sensor error rate was found to be low in that order, HBM and EBM.

FIG. 14 is a diagram showing all 126 combinations ranked in order of lowest average error rate of the five virtual sensors, wherein the positioning method of the present disclosure ranked first overall, and HBM and EBM ranked 10th and 117th, respectively.

Therefore, it was difficult for the conventional methodologies to demonstrate sufficient virtual sensor performance in terms of data-based virtual sensor development, but the positioning method of the present disclosure has confirmed the superiority of the algorithm over the conventional methodologies in that it maximizes the performance of all virtual sensors.

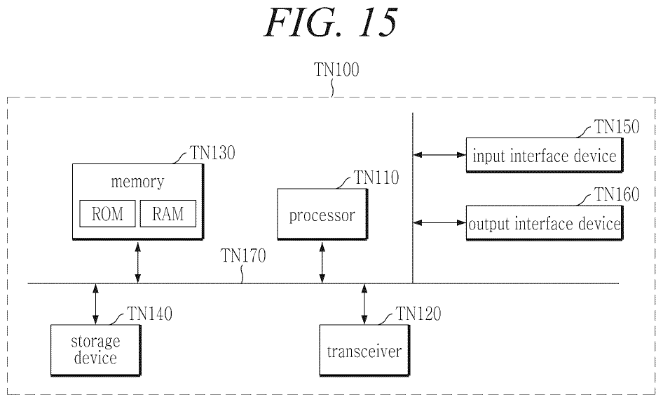

FIG. 15 is a block diagram for explaining a computing device according to one embodiment of the present disclosure.

Referring to FIG. 15, the computing device TN100 may be a device described herein (e.g., the positioning device, the user terminal, etc.).

The computing device TN100 may include at least one processor TN110, a transceiver TN120, and a memory TN130. In addition, the computing device TN100 may further include a storage device TN140, an input interface device TN150, an output interface device TN160, and the like. The components included in the computing device TN100 may be connected by a bus TN170 to communicate with each other.

The processor TN110 may execute a program command stored in at least one of the memory TN130 and the storage device TN140. The processor TN110 may refer to a central processing unit (CPU), a graphics processing unit (GPU), or a dedicated processor on which the methods according to the embodiments of the present disclosure are performed. The processor TN110 may be configured to implement the procedures, functions, and methods described in connection with the embodiments of the present disclosure. The processor TN110 may control each component of the computing device TN100.

Each of the memory TN130 and the storage device TN140 can store various information related to the operation of the processor TN110. Each of the memory TN130 and the storage device TN140 may be configured as at least one of a volatile storage medium and a non-volatile storage medium. For example, the memory TN130 may be configured as at least one of ROM (read only memory) and RAM (random access memory).

The transceiver TN120 can transmit or receive wired signals or wireless signals. The transceiver TN120 may be connected to a network to perform communication.

Meanwhile, the embodiments of the present disclosure are not only implemented through the devices and/or methods described so far, but may also be implemented through a program that realizes the function corresponding to the configuration of the embodiment of the present disclosure or a recording medium on which the program is recorded, and such implementation may be easily implemented by a person of ordinary skill in the art to which the present disclosure pertains from the description of the above-described embodiments.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

### DETAILED DESCRIPTION OF MAIN ELEMENTS

10: communication unit
30: input unit
50: control unit
51: combination generation unit
53: performance evaluation unit
55: position selection unit
70: output unit
90: storage unit
100: positioning device
200: user terminal
350: communication network

What is claimed is:

1. A positioning method performed by a positioning device that selects a position of each of physical sensors and virtual sensors in an indoor space, the method comprising:
generating a position-related combination of the physical sensors and the virtual sensors based on the number of nodes of the physical sensors;
calculating performance of the virtual sensors for each generated combination;
determining whether there is a combination in which the performance of all virtual sensors satisfies a preset criterion among the calculated results; and
selecting, when there is a combination that satisfies the preset criterion, positions included in the combination as positions of the physical sensors and the virtual sensors.

2. The positioning method of claim 1, further comprising:
selecting, when there is no combination that satisfies the preset criterion, a promising combination that affects performance of other virtual sensors more than a preset level and a challenging node, which is a node where virtualization of a virtual sensor is difficult;
updating a parameter set that determines the number of cases related to the combination based on the promising combination and the challenging node that are selected; and
regenerating the combination based on the updated parameter set and repeating the positioning process based on the regenerated combination until the positions of the physical sensors and the virtual sensors are selected.

3. The positioning method of claim 2, wherein in the selecting of the promising combination and the challenging node, the nodes of the physical sensors corresponding to the combination with a best performance of the virtual sensors among the combinations are selected as the promising combination.

4. The positioning method of claim 3, wherein in the selecting of the promising combination and the challenging node, a node of a virtual sensor that does not satisfy the preset criterion in the promising combination is selected as the challenging node.

5. The positioning method of claim 2, wherein in the selecting of the promising combination and the challenging node, after a greater weight is assigned to the virtual sensor as the performance of the virtual sensor is greater than the preset criterion, and a smaller weight is assigned to the virtual sensor as the performance of the virtual sensor is smaller than the preset criterion, the promising combination and the challenging node are selected.

6. The positioning method of claim 2, wherein in the updating, the parameter set is updated to reduce the number of the cases.

7. The positioning method of claim 1, wherein in the calculating, the performance of the virtual sensors is calculated using the mean absolute error.

8. The positioning method of claim 1, wherein in the determining, as a size of the indoor space increases, a tolerance range for the preset criterion is set larger.

9. A positioning device for selecting a position of each of physical sensors and virtual sensors in an indoor space, the device comprising:
a combination generating unit that generates a position-related combination of the physical sensors and the virtual sensors based on the number of nodes of the physical sensors;
a performance evaluation unit that calculates performance of the virtual sensors for each generated combination and determines whether there is a combination in which the performance of all virtual sensors satisfies a preset criterion among the calculated results; and
a position selection unit that when there is a combination that satisfies the preset criterion, selects positions included in the combination as positions of the physical sensors and the virtual sensors.

10. The positioning device of claim 9, wherein when there is no combination that satisfies the preset criterion, the position selection unit selects a promising combination that affects performance of other virtual sensors more than a preset level and a challenging node, which is a node where virtualization of a virtual sensor is difficult, updates a parameter set that determines the number of cases related to the combination based on the promising combination and the challenging node that are selected, and regenerates the combination based on the updated parameter set.

11. The positioning device of claim 10, wherein the position selection unit selects the nodes of the physical sensors corresponding to the combination with a best performance of the virtual sensors among the combinations as the promising combination.

12. The positioning device of claim 10, wherein the position selection unit selects a node of a virtual sensor that does not satisfy the preset criterion in the promising combination as the challenging node.

13. The positioning device of claim 10, wherein the position selection unit selects the promising combination and the challenging node after assigning a greater weight to the virtual sensor as the performance of the virtual sensor is greater than the preset criterion, and assigning a smaller weight to the virtual sensor as the performance of the virtual sensor is smaller than the preset criterion.

14. The positioning device of claim 10, wherein the position selection unit updates the parameter set to reduce the number of the cases.

15. The positioning device of claim 9, wherein the performance evaluation unit calculates the performance of the virtual sensors using the mean absolute error.

16. The positioning device of claim 9, wherein the performance evaluation unit sets a tolerance range for the preset criterion to be larger as a size of the indoor space increases.

17. A positioning system comprising:
a positioning device for selecting a position of each of physical sensors and virtual sensors in an indoor space; and
a user terminal that receives information related to the selected positions of the physical sensors and the virtual sensors from the positioning device and outputs the received information,
wherein the positioning device includes:
a combination generating unit that generates a position-related combination of the physical sensors and the virtual sensors based on the number of nodes of the physical sensors;
a performance evaluation unit that calculates performance of the virtual sensors for each generated combination and determines whether there is a combination in which the performance of all virtual sensors satisfies a preset criterion among the calculated results; and
a position selection unit that when there is a combination that satisfies the preset criterion, selects positions included in the combination as positions of the physical sensors and the virtual sensors.
